(19) United States
(12) Patent Application Publication
(10) Pub. No.: US 2009/0053477 A1
(43) Pub. Date: Feb. 26, 2009

(54) Label That Is Protected From Adhesive Bleeding

(76) Inventors: Dominik Werth, Freising (DE); Michael Limmer, Germering (DE)

Correspondence Address: COLLARD & ROE, P.C., 1077 NORTHERN BOULEVARD, ROSLYN, NY, 11576, US

(21) Appl. No.: 11/886,813

(22) PCT Filed: Feb. 16, 2006
(86) PCT No.: PCT/EP2006/060022

§ 371 Date: Oct. 2, 2007

(30) Foreign Application Priority Data
Mar. 22, 2005 (EP) 05102270.5

(51) Int. Cl. B32B 5/00; B32B 37/00; B05D 1/26; B32B 38/04

(52) U.S. Cl. 428/189; 156/60; 427/8; 156/230; 156/245

(57) ABSTRACT

A label with a reduced risk of adhesive bleeding is described, which has an upper film section, a lower film section connected with the upper film section, and an adhesive layer, which is affixed to the side of the lower film section that faces away from the upper film section, whereby the lower film section consists of a film that does not shrink, and its expanse is slightly smaller at all the label edges than that of the upper film section. Furthermore, a method for the production of such a label is described.

The present invention relates to a label that is protected from adhesive bleeding, as well as to its production.

The adhesive of labels frequently tends to bleed. This is understood to mean the exit of adhesive beyond the label edges. Bleeding can occur, for example, during further processing, during transport to the customer, or also during storage. The exiting adhesive leads to rolled label webs sticking together, and can also have other negative effects, for example during subsequent writing on the label or other further processing steps. For example, printing systems (for subsequent writing on the label) can be contaminated by exiting adhesive.

Bleeding particularly occurs if adhesives having a high flow capacity (such as certain special adhesives) are used and/or if high adhesive application weights are present. However, it is frequently impossible to avoid the use of such adhesives that are capable of flow, at correspondingly high application weights, in order to guarantee secure adhesion on substrata demonstrating difficult surface conditions.

The usual measures to prevent bleeding particularly include cooling during transport, storage and/or further processing. However, cooling systems generally require some technical effort, and cause high operating costs because of their power consumption.

An alternative possibility of avoiding adhesive bleeding consists in a special configuration of the labels themselves. Such a solution is presented in the Offenlegungsschrift DE 10235218 A1. Here, a multi-layer label having a lower film that can shrink is made available. An adhesive-free region is formed at the edge by means of shrinking the lower film. Such labels have proven to be very effective in use, but they cannot be used in all cases. In the case of uses in regions that are exposed to high temperatures, in particular, there is the risk of “subsequent shrinkage” of the lower film, so that the adhesive-free edge becomes larger, in undefined manner, than was originally provided.

It is therefore the task of the present invention to create a label that is protected from adhesive bleeding. In this connection, the risk of subsequent shrinkage, specifically of the lower film (but also of the upper film) is supposed to be avoided. Furthermore, a suitable method for the production of such a label is supposed to be made available.

This task is accomplished by means of a label that has at least an upper film section, a lower film section connected with the upper film section, and an adhesive layer, which is affixed to the side of the lower film section that faces away from the upper film section. In the case of this label, at least the lower film section is configured so as not to shrink, and is kept slightly smaller on all sides, in terms of its area expanse, than the upper film section. In this way, a region is formed towards all the edges, in which little or only a slight amount of adhesive is present, since the upper film section projects beyond the lower film section on the circumference. This excess length is preferably not greater than 1.5 mm. An excess length of about 0.2 to 0.5 mm is particularly preferred for many purposes of use. The upper film section is preferably also configured from a non-shrinking material, but at least from a material that tends to shrink only slightly, in order to avoid subsequent reduction of the excess length by means of shrinkage of the upper film section. A decisive factor for protecting the label from adhesive bleeding is that the upper film section does not shrink significantly at least under storage and transport conditions, since this is where the negative effects of bleeding can become particularly critical. If the label is exposed to extreme ambient influences once it adheres in place, a slight shrinkage behavior of the upper label can be tolerated, up to a certain degree, since then, exiting adhesive might not bring any function-reducing effects of the effect with it.

Along with other possibilities, it is advantageous if the upper and lower film section are connected by means of coextrusion, but preferably, the connection between upper film section and lower film section is structured as an adhesive layer that preferably has an application mass, with reference to area, of less than 30 grams per square meter, in order to also avoid bleeding of this adhesive layer. For the same reason, a relatively “hard” acrylate adhesive, i.e. one that has little tendency to flow, is preferably selected for the adhesive layer between upper and lower film section. Alternatively to such adhesives, the use of a lamination varnish is possible, as are other types of connections using chemical or physical influences, for example by means of chemical or conventional (brought about by means of heat effect) bonding.

In contrast, the adhesive layer on the side of the lower film section that faces away from the upper film is preferably thicker than 40 μm, in practice, probably between 45 and 150 μm thick, in most cases, in accordance with the usual purpose of use of application on “difficult,” i.e. particularly rough or otherwise adhesion-unfriendly surfaces. In particular cases, even thicknesses of the adhesive layer of more than 1 mm can be advantageous. In order to achieve optimal adhesion properties, relatively soft adhesives made of modified acrylate or rubber material are preferably used.

Depending on the purpose of use, the labels according to the invention can advantageously have the most varied features and characteristics that are known from label use. These include imprints containing text, image, or code data, surfaces that are optimized for subsequent writing, or special films, luminescence ink layers, protective layers, punchings, tabs, releasable sections, and security characteristics of the most varied kinds.

In the following, the label according to the invention and corresponding methods provided for its production will be explained, making reference to the related drawings. The representations are purely schematic and not to scale; in particular, layer thicknesses are represented in greatly enlarged manner, for reasons of better illustration.

The figures show:

FIG. 1 a label according to the invention in a side view, in section,

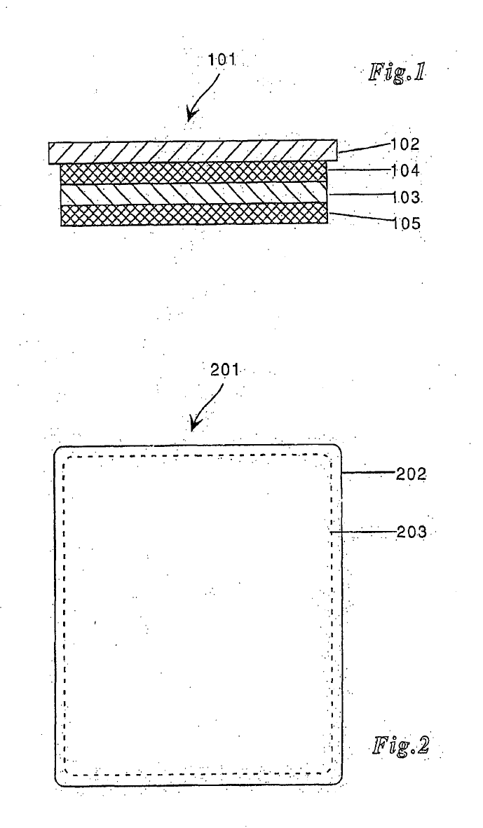

FIG. 2 the label in a top view,

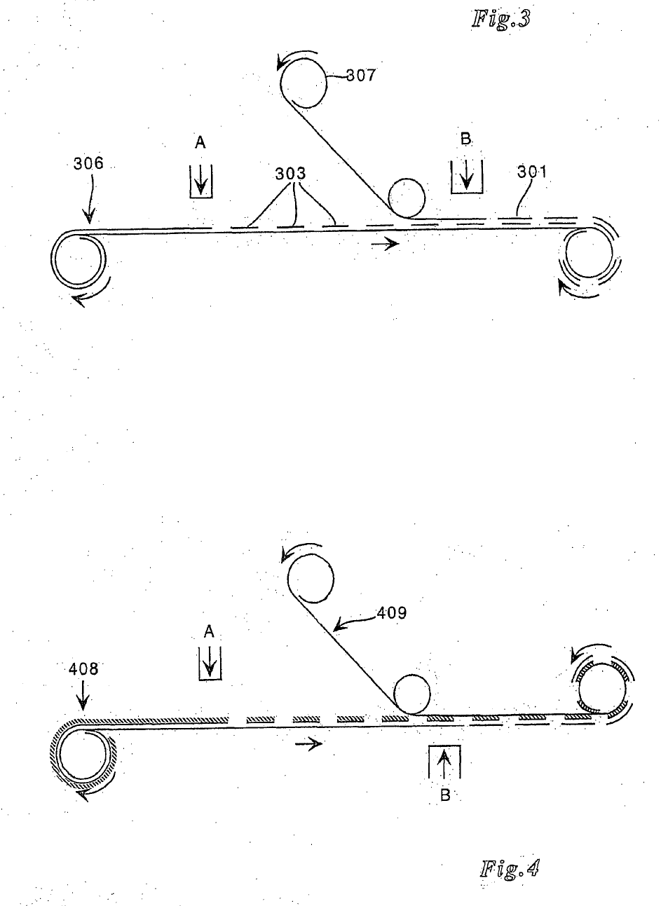

FIG. 3 a preferred production method for the label, according to the invention, and

FIG. 4 another production method according to the invention.

The label 101 shown in FIG. 1 consists of an upper film section 102 and a lower film section 103 coated on its underside with adhesive 105. The two film sections are connected with one another by way of a connecting layer 104. The connecting layer can also be an adhesive, but it can also be a laminating varnish. Furthermore, it is possible that the two film sections were produced from a coextruded film and thus the connecting layer 104 is not necessary. The lower film section is formed from a film that does not tend to shrink. Specifically, this film does not demonstrate any shrinkage up to a temperature range of 50 degrees Celsius, preferably up to 100 degrees Celsius. The lower film section is dimensioned somewhat smaller on all the edges than the upper film section.

In FIG. 2, the label 201 according to the invention (numbered analogously) is shown in a top view. Only the upper film section 202 can be seen, because of its greater dimensions; the lower film section 203 is therefore only indicated with a broken line.

Because of the greater dimensions of the upper film section 202, the label according to the invention demonstrates the same effect as one that consists of two film sections having the same size, in which the lower film section was subsequently shrunk: For the adhesive 105 (FIG. 1), there is a certain room to spread, because of the overlapping region of the upper film section, without bleeding beyond the label edge coming about. In comparison with a “pre-shrunk” label according to the state of the art, however, the advantage is that the lower film section does not shrink even after the label is placed, under other ambient influences, for example the effect of heat.

FIG. 3 shows a preferred production method for the label described above: A composite 306 of carrier tape and first film web equipped to be self-adhesive is punched into lower film sections 303 in a first punch A. Another film web is fed in from a second roll 307 and laminated onto the lower film sections. A second punch B punches out the upper film section, which is dimensioned to be larger towards all sides than the outline of the lower film section, according to the invention. The label 301 is the product described above, which is wound back up onto a roll. To simplify the representation, the removal of the grid after the two punching processes was left out in the figure.

An alternative production possibility of the label is shown in FIG. 4. A coextruded film composite 408, preferably provided with an adhesive layer, consisting of at least two films, is first punched in a punch A in such a manner that only one film layer is punched through. Subsequently, a carrier tape 409 is fed in. Afterwards, a punch B is punched through the second film layer, so that again—this time with side reversal as compared with FIG. 3—the labels according to the invention are present and can be rolled up onto a roll.

Furthermore, it is also possible to apply one of the two film sections of the label onto the other section, using a dispensing method. This method is particularly suitable if the upper film section consists of several individual films or was otherwise pre-treated, for example was provided with complicated imprinting, while the lower film section consists of a simple, untreated film. Since the protection against adhesive bleeding only functions if the two film sections lie on top of one another with accurate fit after dispensing, it is advantageous to check the fit accuracy using inspection systems, preferably electronic image monitoring systems.

It is obvious that such inspection systems can also be used, in practical manner, in the control of the methods described above.

In place of the conventional dispensing method, in which the upper film sections can be dispensed onto the lower film section by way of a dispensing edge, as in label-dispensing methods, a transfer method can also be selected for dispensing the upper film sections: In this connection, the two film sections are present on carrier films, whereby the upper film sections are transferred from their carrier to the lower film sections. In this method, the connecting layer between the upper film sections and their carrier either remains on the carrier or is a dry layer that remains behind, which later forms the top of the label. Preferably, this layer can therefore be imprinted. The transfer method offers the advantage, as compared with the conventional dispensing method, that the fit accuracy of the two film sections can be brought about more easily, once the processing machine has been accurately set.

1. Label with a reduced risk of adhesive bleeding, having an upper film section, a lower film section connected with the upper film section, and an adhesive layer, which is affixed to the side of the lower film section that faces away from the upper film section, wherein the lower film section consists of a film that does not shrink, and its expanse is slightly smaller at all the label edges than that of the upper film section.

2. Label according to claim 3, wherein the lower film section consists of a film that cannot be shrunk thermally.

3. Label according to claim 1, wherein the upper film section consists of a film that cannot shrink or can only shrink slightly.

4. Label according to claim 1, wherein the upper film section consists of a film that cannot shrink or can only shrink slightly at temperatures up to 50 degrees Celsius.

5. Label according to claim 1, wherein the upper film section consists of a film that cannot shrink.

6. Label according to claim 1, wherein the upper film section does not project more than 1.5 mm beyond the lower film section.

7. Label according to claim 6, wherein the upper film section projects beyond the lower film section by 0.2 to 0.5 mm around the circumference.

8. Label according to claim 1, wherein the connection between upper film section and lower film section is configured as an adhesive layer.

9. Label according to claim 8, wherein the adhesive layer between upper film section and lower film section has an application mass, with reference to area, of less than 30 grams per square meter.

10. Label according to one of claims 8, wherein the adhesive layer between upper film section and lower film section consists of an acrylate system.

11. Label according to claim 1, wherein the connection between upper film section and lower film section is configured as a varnish layer.

12. Label according to claim 1, wherein the adhesive layer is thicker than 40 μm.

13. Label according to claim 1, wherein the adhesive layer consists of a modified acrylate or rubber material.

14. Label according to claim 1, wherein it lies on a web, adhering in releasable manner.

15. Method for the production of labels protected from adhesive bleeding, which has the following steps in any desired sequence:
(a) making available a self-adhesive lower film section that is configured so that it does not shrink,
(b) making available an upper film section that is dimensioned to be larger at all the edges,
(c) bringing the two film sections together to form a self-adhesive composite.

16. Method according to claim 15, wherein the upper film section is dispensed onto the lower film section.

17. Method according to claim 16, wherein the upper film section is dispensed onto the lower film section with accurate fit, using at least one inspection system.

18. Method according to claim 17, wherein the upper film section is transferred onto the lower film section from a carrier.

19. Method according to claim 17, wherein the at least one inspection system is an electronic image monitoring system.

20. Method according to claim 15, wherein the two film sections are prepared using at least one punch mold per film section.

21. Method according to claim 20, wherein the two film sections are punched one after the other.

22. Method according to claim 20, comprising the following sequence:
(a) making available a coextruded film web that has at least two layers,
(b) punching a first film layer,
(c) punching a second film layer, whereby the punch mold of the second film layer is structured and oriented in such a manner that the second film layer projects beyond the first film layer at all edges.

23. Method according to claim 22, wherein after punching of the first film layer, adhesive is applied in the region of the first film that remains on the remainder of the film web, layer and a carrier film is applied to the adhesive-coated side.

24. Method according to claim 20, wherein a first film web on a carrier film is made available and punched, and a second film web is brought together with the resulting film sections and punched, in its turn.
